(19) United States
(12) Patent Application Publication
(10) Pub. No.: US 2026/0095078 A1
(43) Pub. Date: Apr. 2, 2026

(54) ROTATING ELECTRICAL MACHINE

(71) Applicant: KANZAKI KOKYUKOKI MFG. CO., LTD., Hyogo (JP)

(72) Inventor: Taiki TAKIHARA, Hyogo (JP)

(21) Appl. No.: 18/901,488

(22) Filed: Sep. 30, 2024

(51) Int. Cl. H02K 11/25; H02K 3/50; H02K 11/00

(52) U.S. Cl. CPC H02K 11/25; H02K 3/50; H02K 11/0094; H02K 2203/09

(57) ABSTRACT

[Problem] The purpose is to improve assemblability and measurement precision when a temperature sensor is attached to a rotating electrical machine. [Solution] A motor (an example of a rotating electrical machine) comprises: a rotor; a stator provided in the radially outside of the rotor; coils provided in the stator; a bus bar supplying electric power to the coils; a bus bar support holding the bus bar; a temperature sensor measuring the temperature of the coils; and a holding member which is attached to the bus bar support and holds the temperature sensor.

### CROSS REFERENCE TO RELATED APPLICATIONS

The present invention claims priority under 35 U.S.C. § 119 to Japanese Application No. 2023-174166, filed on Oct. 6, 2024, the entire contents of which being incorporated herein by reference.

### TECHNICAL FIELD

The present invention relates to a rotating electrical machine comprising a temperature sensor.

### BACKGROUND ART

In a rotating electrical machine such as a motor and a generator, as electric current needs to be controlled to prevent heat generated by coils which are provided in a stator from becoming excessive, a temperature sensor measuring the temperature of coils is provided. In order to increase measurement precision of the temperature, the temperature sensor needs to be closely attached to the coils.

Because of this, conventionally, the temperature sensor has been tied to the coils with a binding band, or the temperature sensor has been adhered to the coils.

However, when the binding band is used, the temperature sensor and the coils may rub against each other by oscillation, resulting in a break. Further, when the temperature sensor is adhered, it takes time to dry an adhesive, resulting in a long assembling cycle time. In addition, in a narrow space, drying of adhesive may be insufficient, causing the adhesive not to be cured. For this reason, a technique for attaching a temperature sensor without the use of a binding band and an adhesive has been studied. For example, Patent Document 1 proposes an apparatus comprising: an elastic part in which a temperature detecting element is pressed against coils; and a fixing part in which the elastic part is fixed to a motor case of a rotating electrical machine. The elastic part is U-shaped from the fixing part to the temperature detecting element in its cross-section.

### PRIOR ART DOCUMENT

### Patent Document

Patent Document 1: International Publication No. WO2011/117985

### SUMMARY OF INVENTION

### Technical Problem

However, the motor case of Patent Document 1 is provided as a housing which surrounds the radially outside of a stator. Since the gap between the motor case and the stator is narrow, it is difficult to arrange an apparatus. If the gap is expanded for the arrangement of the apparatus, upsizing of the motor case is caused. Moreover, because the motor case is designed to place a priority on heat dissipation properties, heat is escaped from the coils through the temperature detecting element and the apparatus, causing measurement precision to be reduced.

In view of the above circumstances, the present invention aims to improve assemblability and measurement precision when a temperature sensor is attached to a rotating electrical machine.

### Solution to Problem

In order to solve the above problems, a rotating electrical machine according to the present invention comprises: a rotor; a stator provided in a radially outside of the rotor; coils provided in the stator; a bus bar supplying electric power to the coils; a bus bar support holding the bus bar; a temperature sensor measuring a temperature of the coils; and a holding member which is attached to the bus bar support and holds the temperature sensor. The temperature sensor may be sandwiched between the holding member and the coils, and the temperature sensor may be pressed against the coils by elasticity of the holding member.

The holding member may be formed with a resin.

The holding member may be attached to the bus bar support by welding.

The holding member may comprise a harness holding part which holds a harness provided in the temperature sensor.

The bus bar support may comprise a restriction part which restricts a movement of a connector provided in the harness.

The holding member may comprise a connector holding part which holds a connector provided in in the harness.

### Advantageous Effects of Invention

According to the present invention, assemblability and measurement precision can be improved when a temperature sensor is attached to a motor.

### BRIEF DESCRIPTION OF DRAWINGS

FIG. 1 is an exploded view illustrating a motor according to one embodiment of the present invention.

FIG. 2 is a perspective view illustrating a stator according to one embodiment of the present invention.

FIG. 3 is a side view illustrating a stator according to one embodiment of the present invention.

FIG. 4 is a cross-sectional view illustrating the section I-I of FIG. 3.

FIG. 5 is a perspective view illustrating a stator according to a variant of one embodiment of the present invention.

FIG. 6 is a side view illustrating a stator according to a variant of one embodiment of the present invention.

FIG. 7 is a cross-sectional view illustrating the section II-II of FIG. 6.

### DESCRIPTION OF EMBODIMENTS

In the following, a rotating electrical machine according to an embodiment of the present invention will be explained with reference to the drawings. Meanwhile, in this embodiment, an example of a motor 1 is shown as the rotating electrical machine; however, the present invention may be applied to a generator.

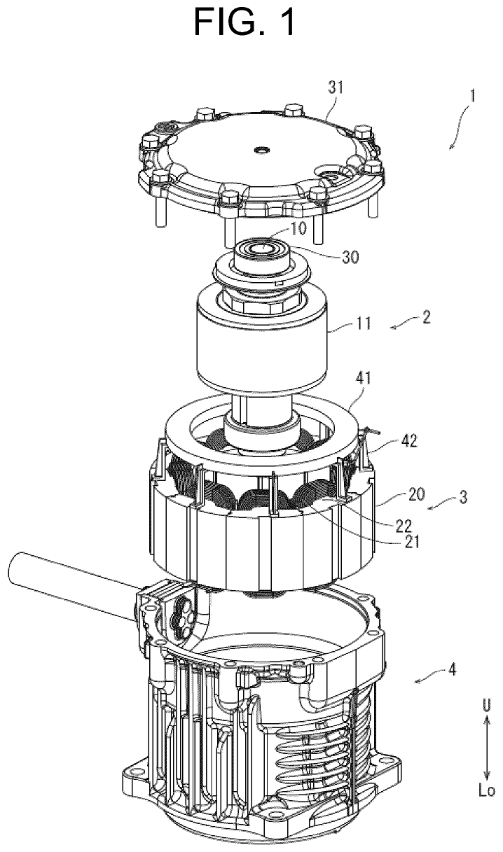

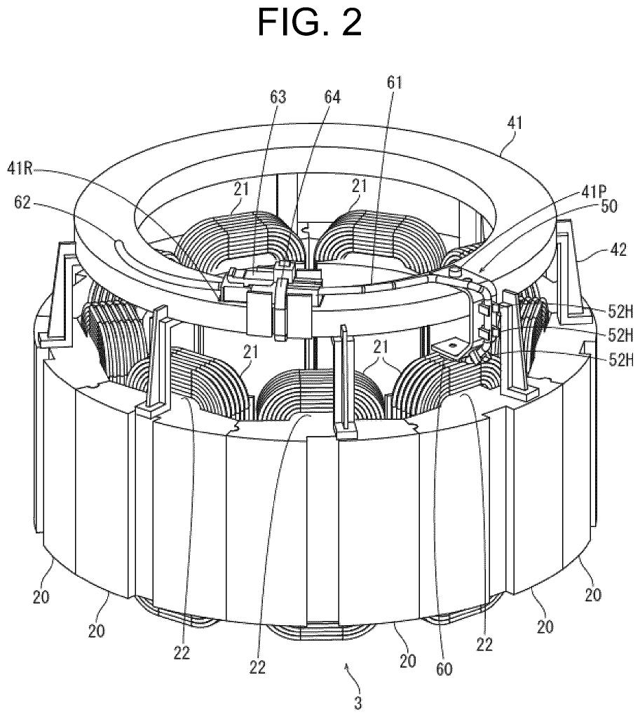

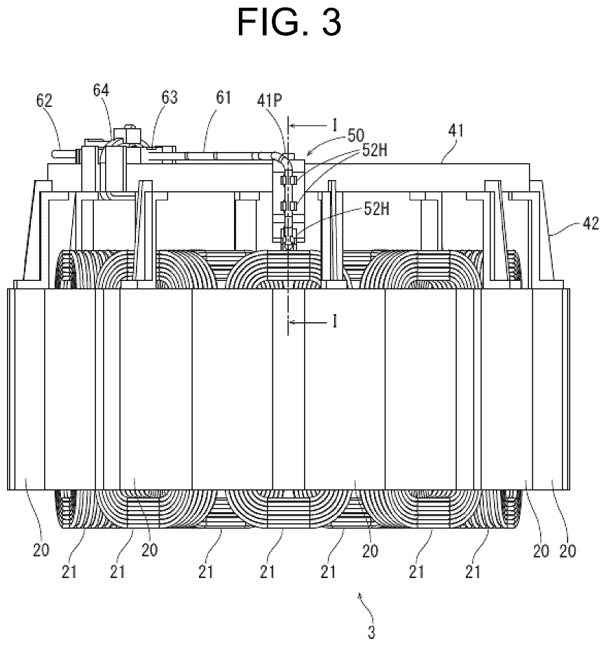

First, the entire structure of the motor 1 will be explained. FIG. 1 is an exploded view illustrating the motor 1. FIG. 2 is a perspective view illustrating a stator 3. FIG. 3 is a side view illustrating the stator 3.

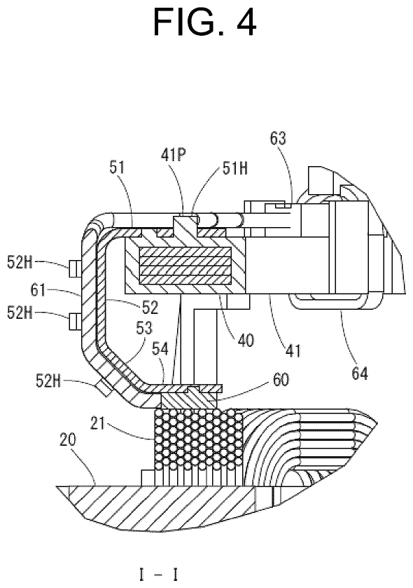

FIG. 4 is a cross-sectional view illustrating the section I-I of FIG. 3. In the following, a case where the axial direction of the rotation axis 10 is defined as the up-down direction will be explained; however, the motor 1 may be installed in any attitude. In each figure, U and Lo indicate up and low, respectively.

The motor 1 comprises a rotor 2, the stator 3 and a housing 4. The rotor 2 has the rotation axis 10 and a rotor core 11. The the rotor core 11 is cylindrically formed and is coaxially fixed to the rotation axis 10. A plurality of permanent magnets (not shown) are provided in the rotor core 11. The stator 3 and the housing 4 are coaxially provided with respect to the rotation axis 10.

The stator 3 (see FIG. 2 and FIG. 3) has a plurality of circumferentially aligning stator cores 20 and a plurality of coils 21 and is arranged radially outside the rotor 2. Their respective stator cores 20 have teeth 22 which protrude radially inward. The stator 3 is formed cylindrically as a whole in which the plurality of stator cores 20 are coupled circumferentially and has an inner space in the radial center (in the further inner side than the plurality of teeth 22). The rotor 2 is arranged in the inner space of the stator core 20 so that the rotor 2 is coaxial with the stator core 20. The plurality of teeth 22 are arranged in the circumference of the stator core 20 at regular intervals, and the coils 21 are wound around their respective teeth 22.

The housing 4 is cylindrically formed with one open end and the other closed bottom end and contains the rotor 2 and the stator 3 so that they are coaxial, and the stator 3 in which the rotor 2 is internally arranged is pressed in the inner periphery surface of the housing 4. Bearings 30 are provided in both the up and down ends of the rotation axis 10. In FIG. 1, only the bearing 30 on the upper part side of the rotation axis 10 is shown. The bearing 30 on the upper part side of the rotation axis 10 is fixed to a lid part 31 of the housing 4, and the bearing 30 on the lower part side of the rotation axis 10 is fixed to the bottom part of the housing 4.

Next, the characteristic structure of this embodiment will be explained. The motor 1 (an example of the rotating electrical machine) according to this embodiment is characterized by comprising: the rotor 2, the stator 3 provided radially outside the rotor 2, the coils 21 provided in the stator 3, a bus bar 40 supplying electric power to the coils 21, a bus bar support 41 holding the bus bar 40, a temperature sensor 60 measuring the temperature of the coils 21, and a holding member 50 which is attached to the bus bar support 41 and holds the temperature sensor 60. Meanwhile, because the rotor 2, the stator 3 and the coils 21 are as described earlier, in the following, the bus bar 40, the bus bar support 41, the temperature sensor 60 and the holding member 50 will be mainly explained.

### Bus Bar and Bus Bar Support

The bus bar 40 (see FIG. 4) is provided on the upper side of the stator 3. The bus bar 40 is formed with a plurality of annularly formed plate-like members which have a radius slightly smaller than that of the stator 3 and which are overlapped in a layered manner (in four layers, for this example). The bus bar 40 is formed with metal having conductivity such as copper. The bus bar support 41 is formed with a resin having an electrical insulating property and covers the bus bar 40 entirely. In addition, since the bus bar support 41 is formed with a resin, its heat insulating property is higher as compared to that of metal and the like. The bus bar support 41 is supported by a plurality of columns 42 which are circumferentially arranged on the upper surface of the stator 3.

A protrusion part 41P and a restriction part 41R are provided on the upper surface of the bus bar support 41. The bus bar support 41 and the protrusion part 41P are integrally formed with the same resin. The protrusion part 41P is a part onto which the holding member 50 described later is welded. The restriction part 41R is provided in a circumferentially different position from the protrusion part 41P. The restriction part 41R is formed with a concave having an upper open side, for example, and a connector 63 described later is contained therein.

### Temperature Sensor

The temperature sensor 60 measures the temperature of the coils 21. The temperature sensor 60 is a thermistor, a thermocouple, etc., for example. One end part of a coil-side harness 61 is connected to the temperature sensor 60. The other end part of the coil-side harness 61 is connected to one end part of an inverter-side harness 62 via the connector 63. The other end part of the inverter-side harness 62 is connected to an inverter (illustration omitted). The connector 63 is contained in the restriction part 41R described above and is tied to the bus bar support 41 using a binder 64 such as a binding band and a binding string.

### Holding Member

The holding member 50 (see FIG. 4) comprises a base part 51, an arm part 52, an oblique part 53 and a sensor holding part 54, and is integrally shaped by a resin.

The base part 51 is arranged so as to be opposite to the upper surface of the bus bar support 41 in the position where the protrusion part 41P is provided. The base part 51 comprises a through-hole 51H which penetrates in the up-down direction. The protrusion part 41P is inserted into the through-hole 51H and is welded.

The arm part 52 is provided downward starting from the radially outside end part of the base part 51 as a starting point. The lower end part of the arm part 52 reaches the lower position than the bottom part of the bus bar support 41. On the radially outside surface of the arm part 52, harness holding parts 52H which hold the coil-side harness 61 are provided in a plurality of places (two places, in this example) in the up-down direction. The harness holding parts 52H are snap-fit like parts into which the coil-side harness 61 is fitted.

The oblique part 53 is provided downward starting from the lower end part of the arm part 52 as a starting point. The oblique part 53 inclines toward the radially inside.

The sensor holding part 54 is provided in the radially inside starting from the lower end part of the oblique part 53 as a starting point.

The sensor holding part 54 faces the upper end part of the coils 21. The temperature sensor 60 is attached to the undersurface of the sensor holding part 54. The temperature sensor 60 is sandwiched between the holding member 50 and the coils 21, and the temperature sensor 60 is pressed against the coils 21 by the elasticity of the holding member 50.

According to the motor 1 according to this embodiment described above, the motor 1 comprises: the rotor 2; the stator 3 provided in the radially outside of the rotor 2; the coils 21 provided in the stator 3; the bus bar 40 supplying electric power to the coils 21; the bus bar support 41 holding the bus bar 40; the temperature sensor 60 measuring the temperature of the coils 21; and the holding member 50 which is attached to the bus bar support 41 and holds the temperature sensor 60. According to this structure, there is a wider space between the coils 21 and the bus bar support 41, as compared to the space between the coils 21 and the housing 4, making the securing of space to arrange the temperature sensor 60 and the holding member 50 easy. In addition, as the bus bar support 41 has a high heat insulating property, heat is hardly escaped from the coils 21 via the temperature sensor 60 and the holding member 50 so that a high degree of measurement precision can be obtained. Therefore, it is possible to improve assemblability and measurement precision when the temperature sensor 60 is attached to the motor 1.

Further, according to the motor 1 according to this embodiment, the temperature sensor 60 is sandwiched between the holding member 50 and the coils 21, and the temperature sensor 60 is pressed against the coils 21 by the elasticity of the holding member 50. According to this structure, the temperature sensor 60 is pressed against the coils 21 without the use of the binder 64 such as a binding band, allowing the number of parts to be restricted. Moreover, with the binder 64, the temperature sensor 60 may be easily displaced, resulting in a break, but according to this embodiment, the temperature sensor 60 is hardly displaced, allowing the break to be prevented.

In addition, according to the motor 1 according to this embodiment, the holding member 50 is formed with a resin.

According to this structure, as the holding member 50 has a high heat insulating property, heat is hardly escaped from the coils 21 via the holding member 50 so that a high degree of measurement precision can be obtained.

Further, according to the motor 1 according to this embodiment, the holding member 50 is attached to the bus bar support 41 by welding. According to this structure, because drying of adhesive is not required, the cycle time can be reduced. Moreover, the number of parts can be restricted as compared to the case where the holding member 50 is attached with screws and the like.

In addition, according to the motor 1 according to this embodiment, the holding member 50 comprises the harness holding part 52H holding a harness (for example, the coil-side harness 61) provided in the temperature sensor 60. According to this structure, the number of parts can be restricted as compared to the case where a harness is held with a separate part from the holding member 50.

Further, according to the motor 1 according to this embodiment, the bus bar support 41 comprises the restriction part 41R which restricts the movement of the connector 63 provided in a harness. According to this structure, the displacement of the connector 63 can be prevented.

The above embodiment may be varied as follows.

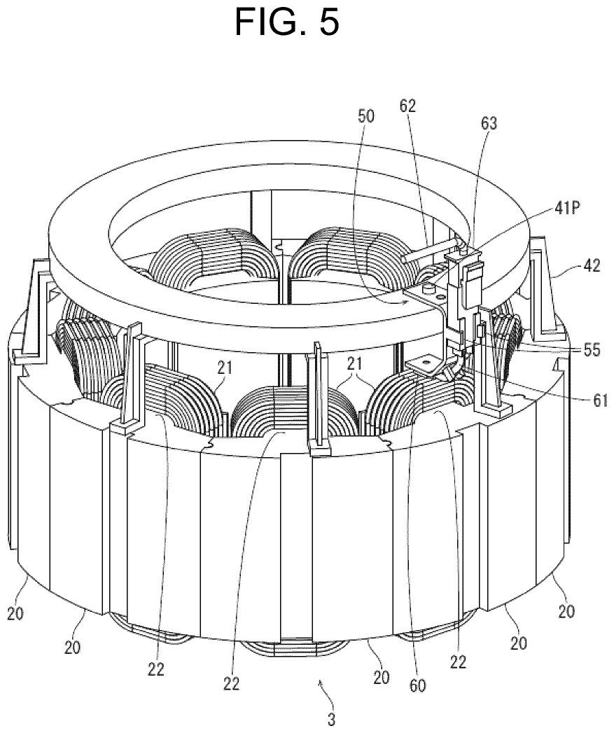

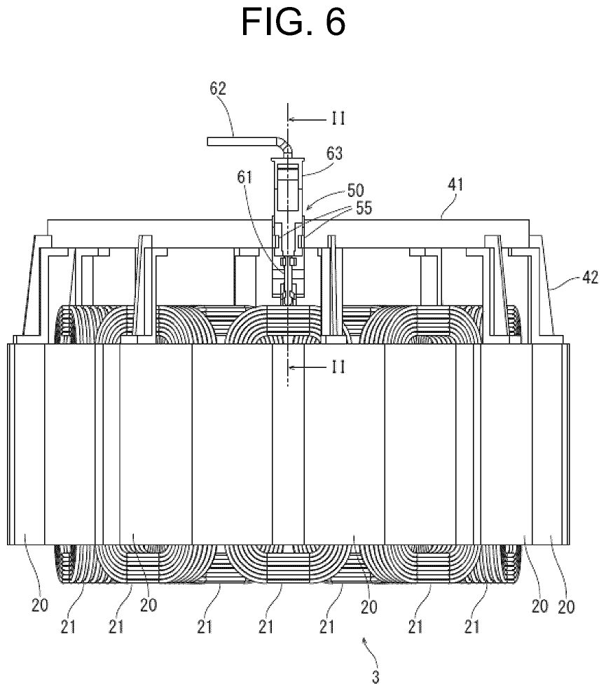

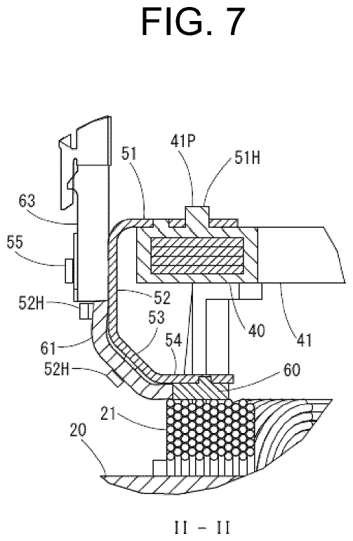

FIG. 5 is a perspective view illustrating the stator 3 according to one variant. FIG. 6 is a side view illustrating the stator 3 according to the variant. FIG. 7 is a cross-sectional view illustrating the section II-II of FIG. 6. In this variant, connector holding parts 55 are provided in the arm part 52 of the holding member 50. The connector holding parts 55 are snap-fit like parts into which the connector 63 is fitted. According to this structure, as the restriction part 41R is not required, it is not necessary to change the design for the bus bar support 41. In addition, since the binder 64 is not required, the number of parts can be restricted.

In the above embodiment, the example in which the restriction part 41R is a concave has been illustrated; however, the restriction part 41R may be a protrusion which protrudes from the upper surface of the bus bar support 41. In this case, a pair of or plural pairs of protrusions may be provided so that the protrusions contact at least one of both the circumferential end surfaces and both the radial end surfaces of the connector 63.

### Supplementary Notes

The above embodiment may be identified as follows.

### <Supplementary Note 1>

A rotating electrical machine characterized by comprising: a rotor;
a stator provided in a radially outside of the rotor;
coils provided in the stator;
a bus bar supplying electric power to the coils;
a bus bar support holding the bus bar;
a temperature sensor measuring a temperature of the coils; and
a holding member which is attached to the bus bar support and holds the temperature sensor.

### <Supplementary Note 2>

The rotating electrical machine according to supplementary note 1, wherein the temperature sensor is sandwiched between the holding member and the coils, and the temperature sensor is pressed against the coils by elasticity of the holding member.

### <Supplementary Note 3>

The rotating electrical machine according to supplementary note 1 or 2, wherein the holding member is formed with a resin.

### <Supplementary Note 4>

The rotating electrical machine according to supplementary note 3, wherein the holding member is attached to the bus bar support by welding.

### <Supplementary Note 5>

The rotating electrical machine according to any one of supplementary notes 1 to 4, wherein the holding member comprises a harness holding part which holds a harness provided in the temperature sensor.

### <Supplementary Note 6>

The rotating electrical machine according to supplementary note 5, wherein the bus bar support comprises a restriction part which restricts a movement of a connector provided in the harness.

### <Supplementary Note 7>

The rotating electrical machine according to supplementary note 5, wherein the holding member comprises a connector holding part which holds a connector provided in the harness.

### REFERENCE SIGNS LIST

1 motor (rotating electrical machine)
2 rotor
3 stator
21 coils
40 bus bar
41 bus bar support
41R restriction part
50 holding member
52H harness holding part
55 connector holding part
60 temperature sensor

1. A rotating electrical machine comprising: a rotor;
a stator provided in a radially outside of the rotor;
coils provided in the stator;
a bus bar supplying electric power to the coils;
a bus bar support holding the bus bar;
a temperature sensor measuring a temperature of the coils; and
a holding member which is attached to the bus bar support and holds the temperature sensor.

2. The rotating electrical machine according to claim 1, wherein the temperature sensor is sandwiched between the holding member and the coils, and the temperature sensor is pressed against the coils by elasticity of the holding member.

3. The rotating electrical machine according to claim 1, wherein the holding member is formed with a resin.

4. The rotating electrical machine according to claim 3, wherein the holding member is attached to the bus bar support by welding.

5. The rotating electrical machine according to claim 1, wherein the holding member comprises a harness holding part which holds a harness provided in the temperature sensor.

6. The rotating electrical machine according to claim 5, wherein the bus bar support comprises a restriction part which restricts a movement of a connector provided in the harness.

7. The rotating electrical machine according to claim 5, wherein the holding member comprises a connector holding part which holds a connector provided in the harness.
